(19) United States
(12) Patent Application Publication
(10) Pub. No.: US 2026/0167430 A1
(43) Pub. Date: Jun. 18, 2026

(54) APPARATUS AND METHOD FOR TRANSPORTING OBJECTS

(71) Applicant: KRONES AG, Neutraubling (DE)

(72) Inventors: Thomas KIENDL, Maxhuette-Haidhof (DE); Manfred KIESLINGER, Stephanskirchen (DE); Wolfgang MAYER, Regensburg (DE); Stefan ELSPERGER, Soechtenau (DE); Michael NEUBAUER, Grassau (DE)

(21) Appl. No.: 19/421,082

(22) Filed: Dec. 16, 2025

(30) Foreign Application Priority Data
Dec. 17, 2024 (DE) 10 2024 138 290.2

(51) Int. Cl. B65G 29/00; B65G 43/02; H02K 41/02

(52) U.S. Cl. CPC B65G 29/00; B65G 43/02; H02K 41/02; B65G 2201/0235; B65G 2203/0275; B65G 2205/00

(57) ABSTRACT

The invention relates, inter alia, to an apparatus for transporting objects. The apparatus has multiple magnetic force segments arranged side-by-side on a closed path curve. The apparatus has multiple motion devices, each of which has an object holder for holding an object and a magnetic force unit for magnetic interaction with the multiple magnetic force segments for driving the respective motion device. The magnetic force units are each arranged outside relative to the closed path curve for movement on a circulating drive path. The object holders are each arranged for transporting the held objects on a transport path inside relative to the circulating drive path.

### TECHNICAL FIELD

### The invention relates to an apparatus and a method for transporting objects, preferably containers.

### TECHNICAL BACKGROUND

In a container treatment system, containers can be treated and transported between the individual parts of the system. A variety of techniques are known for transporting the containers. A known transport technique includes, for example, long-stator linear-motor drives for driving motion devices (shuttles), which transport the containers.

One possibility, for example, is an LLM transport starwheel with individual, circularly arranged long-stator segments. For example, the LLM transport starwheel can allow for a flexible container inlet with a machine arranged downstream.

Conventionally, the objects to be transported in such shuttle systems are guided on the outside of the motor segment or above or below the particular shuttle.

In this connection, reference is made to DE 10 2015 203 042A1, DE 10 2017 01 331A1, and DE 10 2019 110 056A1, for example.

A disadvantage of known systems can be that, due to, for example, the necessary shuttle width and motor system limits, the individual motion devices (shuttles) cannot move completely or closely enough together (e.g., due to collision avoidance, excessive shuttle density, segment loading), especially at higher speeds. This has the result that the objects to be transported cannot enter continuously and be taken over by the motion devices. The pitch circle diameter on which the motion devices move is also fixed and can be adapted to the following machine only to a limited extent. In order to take these system limitations into account, the objects to be transported must, for example, be brought to a minimum distance before entering. In practice, achieving the required minimum distance is possible only with considerable effort and associated disadvantages (e.g., using a belt station, chain overlaps, etc.). Another significant disadvantage can arise in that the minimum distance generated between the objects in a defined manner can also be lost again during entry, e.g., in crash situations, contact with the guides, or objects that have been shifted for other reasons. The process reliability is therefore not optimal.

The invention is based upon the object of creating an improved technique for transporting objects, preferably containers. Preferably, at least some of the disadvantages mentioned above shall be overcome. Preferably, the technique is to allow for object transport by taking over the objects from a continuous or at least nearly continuous object stream.

### SUMMARY OF THE INVENTION

The object is achieved by the features of the independent claims. Advantageous developments are specified in the dependent claims and the description.

One aspect relates to an apparatus, preferably a transport starwheel, for transporting objects, preferably containers. The apparatus has multiple (e.g., stationary) (e.g., electro-) magnetic force segments, preferably long-stator segments. The multiple magnetic force segments are arranged side-by-side on a closed, preferably (e.g., circular) ring-shaped or oval, path curve. The apparatus has multiple motion devices, each of which has an (e.g., active or passive) object holder (e.g., container holder) for holding an object and an (e.g., permanent) magnetic force unit for magnetic interaction with the multiple magnetic force segments for driving the respective motion device. The magnetic force units are each arranged on the outside relative to the closed path curve for movement on a circulating drive path. The object holders are each arranged for transporting the held objects on a transport path located inside relative to the circulating drive path.

In the apparatus, the transport path of the objects, which is usually located on the outside, is advantageously placed on the inside, viz., inside relative to the drive path. This allows the translation ratio “object to required motion device distance” to be positively influenced, so to speak. For each incoming object distance, the transport path or object pitch circle placed on the inside can advantageously result in a corresponding motion device distance in accordance with the translation ratio. However, this motion device distance is now advantageously larger than the actual object distance. This makes it possible to receive objects that enter with a significantly smaller pitch, including small objects/containers without gaps. In general terms, the apparatus can allow for the object holders, which are used to transport the objects, to come closer to one another at a smaller pitch than the pitch of the magnetic units conventionally allows. Advantageously, the apparatus can also significantly simplify the complexity of a restart logic after crash situations (e.g., objects pushed together), since the objects can shift only slightly due to the lack of gaps. A transport path placed on the inside advantageously also contributes to reducing the mass inertia acting upon the motion device, which is also advantageous (e.g., low segment load during acceleration and deceleration).

Preferably, the multiple magnetic force segments are oriented outwards with respect to the closed path curve, and/or the multiple magnetic force units are oriented toward the closed path curve, and/or the multiple magnetic force segments and the magnetic force units are opposite one another.

Preferably, the transport path lies on a container pitch circle of the apparatus. Preferably, the drive path can run around the magnetic force segments on the outside. Preferably, the drive path can surround the closed path curve. For example, the transport path and the drive path can be arranged coaxially with each other.

Preferably, the apparatus is free of further magnetic force segments that are arranged outside relative to the magnetic force segments and/or the magnetic force units, e.g., arranged on a further closed path curve that lies outside relative to or surrounds the closed path curve.

In one exemplary embodiment, the multiple magnetic force units can be driven independently of one another by the multiple magnetic force segments. Preferably, the multiple magnetic force units and the multiple magnetic force segments together form a long-stator linear-motor drive system or a short-stator linear-motor drive system or a planar-motor drive system (e.g., with a closed drive surface). This advantageously allows for the motion devices to be moved individually.

In another exemplary embodiment, the object holders are each arranged inside relative to at least one of the circulating drive path, the closed path curve, the transport path, the multiple magnetic force units, and the multiple magnetic force segments. Alternatively or additionally, the object holders for holding the objects are oriented outwards, and/or the object holders are (e.g., active or passive) container holders (e.g., container clamps or container receptacles or container pockets (container tray)), preferably for holding one container each at a container neck of the container and/or at a container body of the container. This advantageously allows for secure retention of the objects and a simplified structure of the apparatus, since it avoids conflicts in terms of installation space and movement space, especially in the inlet region and the outlet region.

In one embodiment, at least one of the following conditions is met:
the object holders are arranged at a different height than, preferably above or below, the magnetic force units and/or the multiple magnetic force segments; and
the transport path is arranged at a different height than, preferably above or below, the circulating drive path.

Advantageously, the approach of separating the transport height from the motor height can allow for a particularly simple and efficient, constructive implementation of the idea of moving the transport path inwards.

In another embodiment, the multiple motion devices each have an (e.g., rigid) (e.g., carrier) connecting structure, which connects the object holder of the respective motion device and the magnetic force unit of the respective motion device to each other.

In one embodiment variant, at least one of the following conditions is met:
the connecting structure is configured at least in portions as a truss;
the object holder and/or the magnetic force unit is detachably attached to the connecting structure for replacement;
the object holder and/or the magnetic force unit is connected to the connecting structure in a height-adjustable (e.g., vertically movable) manner, preferably via a vertical guide and/or a dovetail joint;
the magnetic force unit is arranged at one of a lower end and an upper end of the connecting structure, and the object holder is arranged at the other of the lower end and the upper end of the connecting structure;
the connecting structure is connected to a central guide column (e.g., located inside), preferably for guiding and optionally supporting the respective motion device on the central guide column.

This advantageously allows for a lightweight and simple structure of the motion devices that can be flexibly adapted to different requirements.

In another embodiment variant, the connecting structure further has an elongated carrier, preferably a vertical carrier. Preferably, the elongated carrier is arranged inside relative to the transport path, and/or the elongated carrier supports the object holder. Optionally, the connecting structure can further have an (e.g., truss) cantilever, which connects, for example, the elongated carrier and the magnetic force unit and optionally supports the magnetic force unit on the elongated carrier. Advantageously, the connecting structure can thus be particularly light and simple.

In one exemplary embodiment, the apparatus further has a, preferably stationary (fixed-in-place), support plate for supporting the objects, held by the object holders, at the base. Preferably, the support plate can be arranged between the object holders and the magnetic force segments. Preferably, the support plate can have a curved course, which follows the transport path. Advantageously, this can significantly simplify the structure of the object holders and of the motion devices, since they preferably do not have to bear the weight of the objects during transport.

In a further exemplary embodiment, the apparatus further has a side guide element, preferably a side railing or side wall, for laterally guiding the objects, held by the object holders, on the transport path. Preferably, the side guide element can be arranged outside relative to the object holders and/or the transport path. Preferably, the side guide element can have a curved course, which follows the transport path. Advantageously, this can significantly simplify the structure of the object holders, since they preferably only need to push the objects during transport.

In one embodiment, the apparatus further has an inlet conveyor, which is arranged to transfer the objects to the multiple motion devices. Preferably, the inlet conveyor can have a frame with a cutout. For example, the cutout can span part of the magnetic force segments (e.g., in a bridge-like manner). Alternatively or additionally, portions of the motion devices (e.g., portions of the connecting structures, e.g., the cantilevers, and/or the magnetic force units and/or their housings) can be moved through the cutout during operation of the apparatus. This advantageously makes it possible, in a constructively simple manner, for the inlet conveyor to run all the way to the transport path now located inside.

In another embodiment, the magnetic force units are (e.g., partially or completely) accommodated in a housing of the respective motion device. The object holders and the housings are dimensioned in such a way that, when adjacent motion devices move together, the object holders and/or the objects touch one another, while the housings are still spaced apart. Advantageously, this allows for objects to be taken over from a continuous inlet stream.

In one embodiment variant, the multiple motion devices are guided without rollers and/or on a central guide column of the apparatus and optionally supported (e.g., via the connecting structure). Alternatively, the multiple motion devices can, for example, each have at least one guide roller, which guides and optionally supports the respective motion device along a circulating guide track. This advantageously allows for safe and reliable guidance of the motion devices and thus of the object holders and the magnetic force units.

In another embodiment variant, the apparatus further has a locking device, which is arranged in an inlet region of the apparatus and can be actuated (e.g., by a processing device of the apparatus) selectively to block (and back up) or release an object inlet stream. Preferably, the locking device can have a movable (e.g., extendable and retractable or pivotable) locking element (e.g., locking finger, locking pin, or locking barrier) for blocking the objects of the object inlet stream. The locking device can advantageously prevent the transport path from filling up with objects in the event of faults. Instead, the locking device can back up the objects on an inlet conveyor until the fault is remedied. The backed-up objects can then be taken over one after the other by the motion devices in the inlet region, preferably without gaps, and transported away.

In one exemplary embodiment, the apparatus further has a processing device configured to operate the multiple magnetic force segments, and/or magnetic force units in such a way that
the object holders of the multiple motion devices can take over a continuous or nearly continuous object inlet stream (e.g., in an inlet region of the apparatus), and, optionally,
the motion devices increase or decrease a distance between adjacent, transported objects from an inlet region to an outlet region of the apparatus, preferably to a predefined object distance (e.g., equal to a predefined pitch of transport elements of an outlet conveyor of the apparatus).

This also advantageously allows for a control system implementation of the object takeover by the motion devices from a continuous inlet stream.

Preferably, the term “processing device” can refer to an electronic system (for example, configured as a driver circuit or with microprocessor(s) and data memory) which, depending upon the configuration, can perform open-loop and/or closed-loop control tasks and/or processing tasks. Although the term “control” is used herein, this can also comprise or be understood as “closed-loop control” or “control with feedback” and/or “processing” as appropriate. The processing device can, for example, be a central processing device or have multiple decentralized or distributed processing units.

A further aspect relates to a container treatment system (e.g., for changing the temperature of, producing, cleaning, coating, testing, rinsing, filling, closing, pasteurizing, decorating, labeling, printing, marking, laser marking, and/or packaging containers for liquid or pasty media, preferably beverages, liquid foods, or products from the pharmaceutical or healthcare industry). The container treatment system can have the apparatus as disclosed herein. The container treatment system can, for example, be a beverage filling plant.

For example, the containers can be configured as bottles, cans, canisters, cartons, flasks, vials, tubes, etc.

A further aspect relates to a method for transporting objects, preferably containers, and/or by an apparatus as disclosed herein. The method involves: transporting the objects on a transport path, by object holders of multiple motion devices, wherein:
the transport path is arranged inside relative to a circulating drive path;
(e.g., permanent) magnetic force units of the multiple motion devices move on the circulating drive path, driven by magnetic interaction with multiple (e.g., stationary) (e.g., electro-or permanent) magnetic force segments (e.g., long-stator segments) arranged side-by-side on a closed (e.g., preferably (e.g., circular) ring-shaped or oval) path curve; and
the circulating drive path is arranged outside relative to (or surrounds) the closed path curve.

Advantageously, the method can achieve the same advantages as already described with reference to the apparatus. The same applies to the preferred examples of the method explained below.

In one exemplary embodiment, the method further comprises at least one of the following:
taking over the objects by the object holders of the multiple motion devices from a continuous or a nearly continuous object inlet stream (e.g., partial stream of a total stream);
transferring the objects by the object holders of the multiple motion devices to an object outlet stream, in which adjacent objects are positioned at a predefined object distance from one another;
pushing the objects during transport by the object holders of the multiple motion devices over a, preferably curved, support plate and/or along a, preferably curved, side guide element;
blocking an object inlet stream to the multiple motion devices by a locking device, preferably in the event of at least one of: an error during transport, takeover, or transfer; a malfunction of one of the multiple motion devices; a malfunction of one of the multiple magnetic force segments; a malfunction of a device for treating and/or transporting the objects, which device is arranged downstream of the multiple motion devices; detected damage to an object; and an operator input.

It is also possible that the objects be taken over by the object holders from an object inlet stream that has objects, e.g., containers, entering at arbitrary distances one after the other.

The preferred embodiments and features of the invention described above can be combined with one another as desired. In particular, all features described in relation to the apparatus are also applicable and claimable in combination with the method, and vice versa.

### BRIEF DESCRIPTION OF THE FIGURES

Further details and advantages of the invention are described below with reference to the accompanying drawings. In the drawings:

FIG. 1 shows a schematic diagram of an apparatus for transporting objects according to an exemplary embodiment;

FIG. 2 shows a perspectival view of an exemplary apparatus for transporting objects;

FIG. 3 shows a perspectival view of a portion of the exemplary apparatus of FIG. 2; FIG. 4 shows a perspectival view of a further portion of the exemplary apparatus of FIG. 2;

FIG. 5 shows a perspectival view of a motion device of the exemplary apparatus of FIG. 2;

FIG. 6 shows a further perspectival view of the motion device of FIG. 5; and

FIG. 7 shows a schematic view of the drive path and transport path of the exemplary apparatus.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

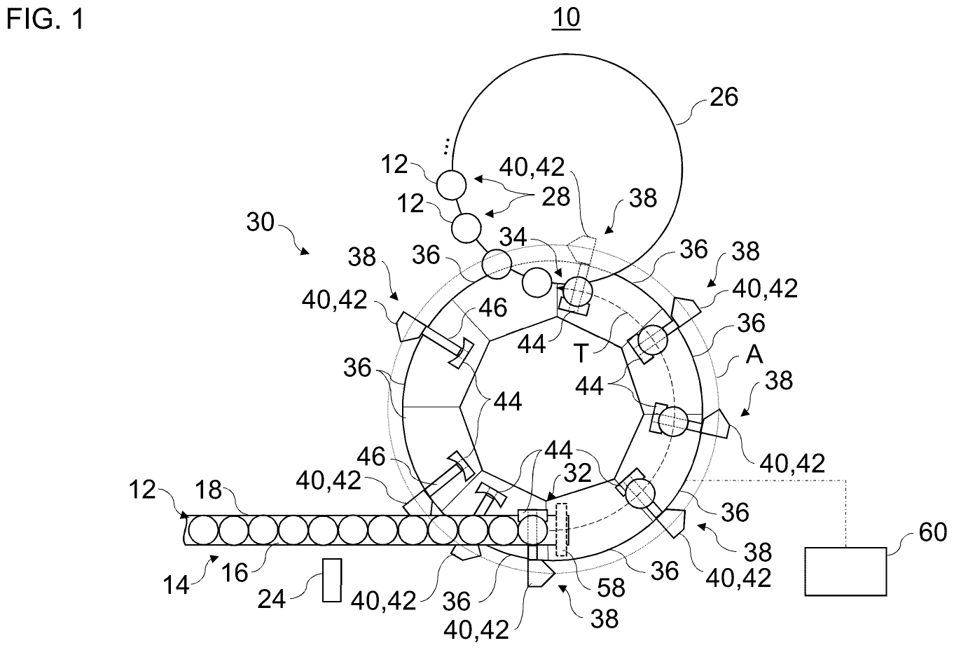

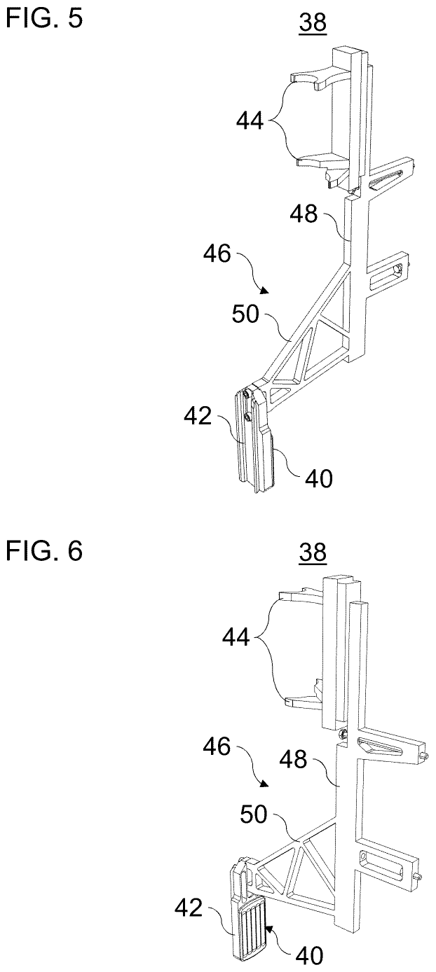

FIGS. 1 to 6 show an apparatus 10 (or portions thereof) for transporting objects (articles) 12. The objects 12 are preferably embodied as individual containers or container bundles. Particularly preferably, the apparatus 10 is comprised in a container treatment system.

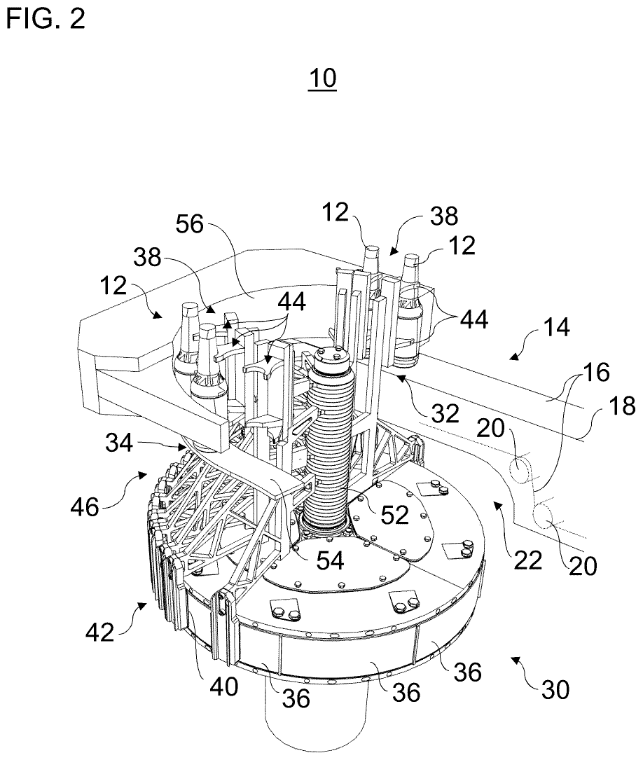

The apparatus 10 is described in more detail below with reference to FIGS. 1 to 6. FIG. 1 shows a schematic diagram of the apparatus 10. In contrast, FIGS. 2 to 6 show perspectival construction views of a preferred exemplary embodiment of the apparatus The apparatus 10 has an (e.g., intermediate) conveyor (transporter) 30 with multiple magnetic force segments 36 and multiple motion devices 38. Optionally, the apparatus 10 may further have, for example, an inlet conveyor 14, a sensor apparatus 24, an outlet conveyor 26, a locking device 58, and/or a processing device 60 (see FIG. 1).

### The Inlet Conveyor 14 Can Transport the Objects 12 to the Conveyor 30.

The inlet conveyor 14 can transport the objects 12 preferably in an upright position and/or support them at the base. Preferably, the inlet conveyor 14 can be a linear conveyor. Preferably, the inlet conveyor 14 can transport the objects 12 in a row one after the other. The inlet conveyor 14 is preferably single-lane.

Specifically, the inlet conveyor 14 can transport an inlet stream of the objects 12 to an (object) inlet region 32 of the conveyor 30. In the object inlet stream, the objects 12 can be positioned substantially without gaps or almost without gaps relative to one another. Preferably, adjacent objects 12 can touch one another.

For example, the inlet conveyor 14 can have a circulating conveying element 16. The circulating conveying element 16 can, for example, be a belt, a plate conveying element, a mat conveying element, or a chain conveying element.

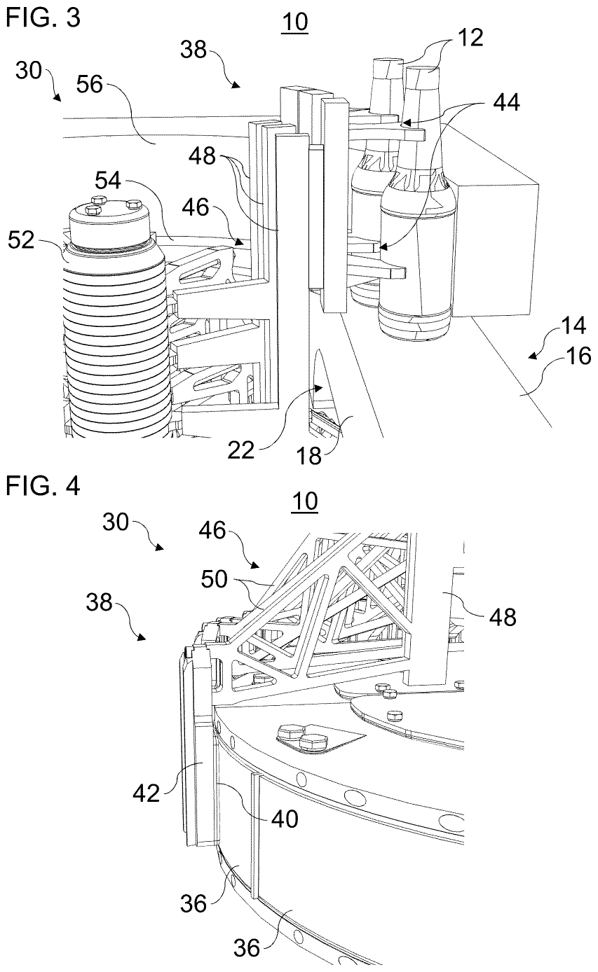

The circulating conveying element 16 can, for example, be guided and driven in a frame 18 of the inlet conveyor 14 (see FIGS. 2 and 3). The frame 18 can be open or clad. For example, the frame 18 can be clad in a closed housing, preferably a conveying element box (e.g., chain box).

For example, a drive wheel and multiple deflection wheels 20 can be rotatably mounted in/on the frame 18 (see FIG. 2). The drive wheel can drive and guide the circulating conveying element 16 for conveying the objects 12. The deflection wheels 20 can guide the circulating conveying element 16-for example, in corner region of the frame 18.

Preferably, the frame 18 of the inlet conveyor 14 can have a cutout 22 for arranging a portion of the conveyor 30 (see FIGS. 2 and 3). Preferably, the cutout 22 can be arranged in an inlet region 32 of the conveyor 30.

The cutout 22 can span a portion of the conveyor 30. For example, the cutout 22 can span the portion of the conveyor 30 in a bridge-like manner. For example, the cutout 22 can span part of the magnetic force segments 36 of the conveyor 30. The cutout 22 can, for example, be substantially rectangular.

Preferably, the cutout 22 can create a movement space for the passage of portions of the motion devices 38. For example, during operation of the apparatus 10, the connecting structures 46 (e.g., their cantilevers 50; see FIGS. 4 to 6) of the motion devices 38 can move through the cutout 22 or the movement space created by the cutout 22.

For example, at least one deflection wheel 20 of the inlet conveyor 14 can be arranged to guide the circulating conveying element 16 along the cutout 22 or following the cutout 22 (see FIG. 2).

The cutout 22 can preferably be arranged on a return run or lower run of the inlet conveyor 14. Particularly preferably, the cutout 22 can be arranged on a lower return run of the inlet conveyor 14.

The sensor apparatus 24 is shown in FIG. 1 only by way of example. For example, the sensor apparatus 24 can have one sensor or multiple sensors spaced apart from one another. The sensor apparatus 24 can preferably be arranged laterally next to or directly above the inlet conveyor 14.

The sensor apparatus 24 can detect the objects 12 of the object inlet stream. Preferably, the sensor apparatus 24 can detect when a particular object 12 passes a specific position along the inlet conveyor 14. However, it is also possible that the sensor apparatus 24 be able to, for example, directly detect current positions of the objects 12 or directly detect spatial and/or temporal distances of the objects 12 from one another.

A signal output of the sensor apparatus 24 regarding the detected objects 12 can be received by the processing device 60. Depending thereon, the processing device 60 can, for example, control a movement of the motion devices 38 for taking over the objects 12.

The outlet conveyor 26 is shown in FIG. 1 only by way of example. The outlet conveyor 26 can transport the objects 12 away from the conveyor 30. Preferably, the outlet conveyor 26 can take over the objects 12 in an (object) outlet region 34 of the conveyor 30 and transport them away.

The outlet conveyor 26 can, for example, have multiple transport elements 28. The objects 12 can be transported by the transport elements 28. Specifically, the transport elements 28 can transport the outlet stream of the objects 12 away from the outlet region 34 of the conveyor 30 one after the other.

The transport elements 28 can, for example, be configured as object holders, preferably container holders. Preferably, the transport elements 28 can each have a support plate, on which an object 12 can stand upright. Alternatively or additionally, the transport elements 28 may, for example, have a clamp or gripper that can hold an object 12 by its lateral surface, neck, and/or neck ring.

The transport elements 28 are movable for transporting the objects 12. The outlet conveyor 26 is particularly preferably configured as a rotary conveyor. The transport elements 28 can be moved along a circular path of the rotary conveyor for transporting the objects 12.

It is preferred that the outlet conveyor 26 itself be part of an object treatment apparatus for treating the objects 12. For example, the object treatment apparatus can fill, close, or decorate (e.g., label) the objects 12, which are preferably configured as containers, while transporting the objects 12 by the transport elements 28.

For example, the object treatment apparatus can be configured as a filling apparatus for filling the objects 12. The filling apparatus can include the outlet conveyor 26. The filling apparatus can fill the objects (e.g., containers) 12, preferably with a liquid or pasty medium. The filling apparatus is preferably configured as a rotary filling apparatus. The filling apparatus can have multiple filling valves for filling multiple objects 12 simultaneously or with a temporal overlap. For example, the filling valves can be arranged around a circumference of a filler carousel of the rotary filling apparatus.

Alternatively, the object treatment apparatus can, for example, be a closure apparatus for closing the objects 12. The closure apparatus can include the outlet conveyor 26. The closure apparatus can close the objects (e.g., containers) 12, for example, with a lid, a cork, a crown cork, or a screw cap. The closure apparatus can preferably be configured as a rotary closure apparatus. The closure apparatus can have multiple closure stations for closing multiple objects 12 simultaneously or with a temporal overlap. For example, the closure stations can be arranged around a circumference of a closure carousel of the rotary closure apparatus.

Alternatively, the object treatment apparatus can, for example, be a labeling apparatus for labeling the objects 12. The labeling apparatus can include the outlet conveyor 26. The labeling apparatus can label the objects (e.g., containers) 12-for example, with self-adhesive labels, cold glue labels, or roll labels. The labeling apparatus can preferably be configured as a rotary labeling apparatus. In the labeling apparatus, the transport elements 28 can, for example, be configured as rotatable object receptacles (e.g., object turntables) for the objects 12, which are arranged around a circumference of a labeling carousel of the rotary labeling apparatus. The transport elements 28 with the objects 12 received therein or thereon can be moved past at least one labeling unit of the labeling apparatus. The at least one labeling unit can, for example, be arranged on a periphery of the rotary labeling apparatus.

Preferably, transport elements 28 that are adjacent to one another are arranged at a predetermined, fixed pitch from one another.

The conveyor 30 can transport the objects 12 from its inlet region 32 to its outlet region 34. In the inlet region 32, the conveyor 30 can take over the objects 12 from the inlet conveyor 14. In the outlet region 34, the conveyor 30 can transfer the objects 12 to the outlet conveyor 26. Preferably, the conveyor 30 can be configured as a transport starwheel, which can transport the objects 12 on a circular path.

The conveyor 30 has multiple magnetic force segments 36 and multiple motion devices 38. Optionally, the conveyor 30 can, for example, also have a support plate 54 and/or a side guide element 56 (see FIGS. 2 and 3).

The magnetic force segments 36 are arranged side-by-side on a closed (path) curve. The path curve or the arrangement of the magnetic force segments 36 can, for example, be circular ring-shaped, as shown in FIG. 1 by way of example. Alternatively, the path curve or the arrangement of the magnetic force segments 36 can be oval, for example.

Preferably, the magnetic force segments 36 are all arranged at the same height. The path curve can preferably lie in a horizontal plane.

For example, the magnetic force segments 36 each have one or more magnets, e.g., permanent magnets or electromagnets. Preferably, the magnetic force segments 36 are stationary or fixed in place.

Preferably, the magnetic force segments 36 or their magnets are oriented outwards with respect to the closed path curve.

The motion devices 38 are used to transport the objects 12. The motion devices 38 can also be referred to as movers or shuttles. Preferably, the objects 12 can each be transported individually by one of the motion devices 38. Alternatively, for example, multiple objects 12 can be transported per motion device 38, or multiple motion devices 38 together transport one object 12—for example, held between the multiple motion devices 38.

The motion devices 38 each have a magnetic force unit 40 and an object holder 44 for holding (at least) one object 12 during transport. Optionally, the motion devices 38 can each have a connecting structure 46.

The magnetic force units 40 are used to magnetically interact with the multiple magnetic force segments 36 for driving the respective motion device 38.

For example, the magnetic force units 40 each have one or more magnets, e.g., permanent magnets or electromagnets. Preferably, the magnetic force units 40 or their magnets can be partially or completely accommodated in a housing 42 of the respective motion device 38.

The magnetic force units 40 are arranged outside relative to the magnetic force segments 36, or relative to the closed path curve on which the magnetic force segments 36 are arranged. The magnetic force units 40 are arranged for movement on a circulating drive path A. The drive path A is accordingly arranged outside relative to the closed path curve on which the magnetic force segments 36 are arranged, or outside relative to the magnetic force segments 36.

For example, the magnetic force units 40 or their magnets can be oriented toward the closed path curve on which the magnetic force segments 36 are arranged. The magnetic force segments 36 and the magnetic force units 40 can be directly opposite one another.

Preferably, the magnetic force units 40 can be driven independently of one another or individually by the magnetic force segments 36. The motion devices 38 can accordingly be moved independently of one another and individually driven magnetically.

For example, the motion devices 38 can be driven by a long-stator linear-motor drive system, a short-stator linear-motor drive system, or a planar-motor drive system of the apparatus 10 or of the conveyor 30. That is to say, the magnetic force units 40 and the magnetic force segments 36 can together form a long-stator linear-motor drive system or a short-stator linear-motor drive system or a planar-motor drive system.

The conveyor 30 is particularly preferably configured as a long-stator linear-motor conveyor. The magnetic force segments 36 can be configured as long-stator segments. Together, the long-stator segments can form a, preferably (e.g., circular) ring-shaped or oval, long stator. The long-stator segments can each have electromagnets for bringing about a movement or drive of the magnetic force units 40 equipped with permanent magnets.

However, it is also possible, for example, for the conveyor 30 to be a short-stator linear-drive conveyor or a planar-motor conveyor.

In the short-stator linear-motor conveyor, the magnetic force segments 36 and the magnetic force units 40 can together form a short-stator linear-motor drive system. The magnetic force units 40 can have electromagnets for forming a short stator, which can enter into magnetic interaction with stationary permanent magnets of the magnetic force segments 36 for driving the respective motion device 38.

The planar-motor conveyor can move the motion devices 38 with at least two degrees of freedom (circumferential direction and z-direction) over a preferably closed drive surface of a stator made of the magnetic force segments 36 (not shown in FIG. 1). The magnetic force segments 36 and the magnetic force units 40 can together form a planar-motor drive system. The stator made of the magnetic force segments 36 can also be referred to as a platform or base element. It is also possible that a lifting movement and/or a tilting movement of the motion devices 38 relative to the stator/base element also be able to be controlled by the magnetic interaction. The basic element can preferably be segmented into tiles. The stator or the magnetic force segments 36 can be formed, for example, by movable, e.g., rotatable, permanent magnets or by stationary electromagnets. The magnetic force units 40 preferably have permanent magnets.

The object holders 44 can be active or passive.

Preferably, an object holder 44 has at least one object pocket (object receptacle or object tray) that can contact the object 12 in contact with a neck and/or lateral surface (body) of the object 12. The object 12 can be at least partially contained in the object pocket, preferably container pocket. For example, the object 12 can be pushed and thus transported by the object pocket when moving the respective motion device 38. Alternatively, the object holder 44 can, for example, have a support plate, on which an object 12 can stand upright. Alternatively or additionally, the object holder 44 can have a clamp or gripper that can hold an object 12 by its lateral surface, neck, and/or neck ring.

The object holders 44 are arranged such that they transport the held objects 12 on a transport path T which is inside relative to the circulating drive path A.

For example, the object holders 44 can each be arranged inside relative to the circulating drive path A, the closed path curve, the transport path T, the magnetic force units 40, and/or the magnetic force segments 36.

Preferably, the object holders 44 can be oriented outwards for holding the objects 12. In a top view of the apparatus 10, the objects 12 can preferably be positioned between the object holder 44 of the respective motion device 38, which object holder is preferably located inside, and the magnetic force unit 40 of the respective motion device 38, which magnetic force unit is preferably located outside.

Preferably, the object holders 44 are arranged at a different height than the magnetic force units 40 and the magnetic force segments 36. For example, the object holders 44 can be arranged above or below the magnetic force units 40 and the magnetic force segments 36. Accordingly, the transport path T can be arranged at a different height than the circulating drive path A-for example, above or below it. In the exemplary embodiment shown in FIGS. 2 to 6, the object holders 44 are arranged, for example, above the magnetic force units 40 and the magnetic force segments 36, whereby the transport path T is also arranged above the drive path A.

The connecting structure 46 can connect the object holder 44 of the respective motion device 38 and the magnetic force unit 40 of the respective motion device 38 to each other. The connecting structure 46 is preferably rigid. Preferably, the connecting structure 46 can transmit a movement of the magnetic force unit 40 to the object holder 44.

For example, an upper end of the connecting structure 46 can be directly connected to the object holder 44, and a lower end of the connecting structure 46 can be directly connected to the magnetic force unit 40 and/or the housing 42, or vice versa.

Preferably, for replacement, the object holder 44 can be detachably attached to the connecting structure 46, e.g., at an upper end region of the connecting structure 46, e.g., via a screw, plug, and/or clamp connection.

The object holder 44 is particularly preferably connected to the connecting structure 46 in a height-adjustable (e.g., vertically movable) manner. For example, the connecting structure 46, e.g., an upper end region of the connecting structure 46, can be connected to the object holder 44 via a vertical guide and/or via a dovetail joint. Preferably, the object holder 44 can be fastened to the connecting structure 46 in different height positions, preferably steplessly.

Preferably, for replacement, the housing 42 and/or the magnetic force unit 40 can be detachably attached to the connecting structure 46, e.g., to a lower end region of the connecting structure 46, e.g., via a screw, plug, and/or clamp connection.

Preferably, the magnetic force unit 40 is connected to the connecting structure 46 in a height-adjustable (e.g., vertically movable) manner, e.g., via the housing 42. For example, the connecting structure 46, e.g., a lower end region of the connecting structure 46, can be connected to the magnetic force unit 40 and/or the housing 42 via a vertical guide and/or via a dovetail joint. Preferably, the magnetic force unit 40 can be fastened to the connecting structure 46 in different height positions, preferably steplessly.

For example, the connecting structure 46 can have an elongated carrier 48 and a cantilever 50 (see, for example, FIGS. 3 to 6).

The elongated carrier 48 can, for example, be rod-, pole-, beam-, or strip-shaped. Preferably, the elongated carrier 48 is a vertical carrier. The carrier 48 can preferably be arranged inside relative to the object holder 44 or the transport path T. Preferably the carrier 48 can have an upper end region, to which the object holder 44 is detachably attached, e.g., via a vertical guide and/or a dovetail joint, or simply screwed together.

The cantilever 50 can preferably be arranged directly below the object holder 44 of the respective motion device 38. For example, the cantilever 50 can extend from the carrier 48, e.g., radially outwards and/or toward the housing 42 and/or the magnetic force unit 40 of the respective motion device 38.

The cantilever 50 can connect the carrier 48 and the magnetic force unit 40—for example, via the housing 42. Preferably, the housing 42 and/or the magnetic force unit 40 can be arranged at one end of the cantilever 50. Preferably, the housing 42 and/or the magnetic force unit 40 can be detachably attached to the end of the cantilever, e.g., via a vertical guide and/or a dovetail joint, or screwed or welded together.

Preferably, the cantilever 50 can support the housing 42 and/or the magnetic force unit 40 on the carrier 48. At least, the cantilever 50 can transfer a movement of the magnetic force unit 40 to the carrier 48 and thus to the object holder 44.

Preferably, the connecting structure 46 can be configured at least in portions as a truss. For example, the cantilever 50 can be implemented in a truss construction.

Preferably, the connecting structures 46 are arranged above the magnetic force segments 36. For example, the carriers 48 and/or the cantilevers 50 can be arranged above the magnetic force segments 36, preferably directly above the magnetic force segments 36.

It is possible that the motion devices 38 be guided and optionally supported on a central guide column 52 (see, for example, FIGS. 2 and 3). The guide column 52 can, for example, be centrally located inside relative to the transport path T and/or the drive path A.

For example, the motion devices 38 can be guided and supported on the guide column 52 via the connecting structures 46. Preferably, the connecting structures 46 can be rotatably connected to the guide column 52—for example, via the carrier 48.

The motion devices 38 guided on the central guide column 52 are preferably without rollers. Alternatively, it is possible, for example, that the multiple motion devices 38 each have at least one guide roller, which guides and optionally supports (not shown) the respective motion device 38 along a circulating guide track. The at least one guide roller can be arranged, for example, on the connecting structure 46 and/or on the housing 42 and/or on the object holder 44.

The support plate 54 can be used to support the objects 12, held by the object holders 44, at the base (see FIGS. 2 and 3). For example, the objects 12 can be pushed over the curved support plate 54 by the object holders 44 of the motion devices 38 during transport.

Preferably, the support plate 54 can have a curved course, which follows the transport path T. Preferably, the support plate 54 can be arranged directly below the transport path T. For example, the support plate 54 can be arranged between the object holders 44 and the magnetic force segments 36.

The side guide element 56 can be used to laterally guide the objects 12, held by the object holders 44, on the transport path T (see FIGS. 2 and 3). For example, the objects 12 can be pushed along the side guide element 56 by the object holders 44 of the motion devices 38 during transport.

For example, the side guide element 56 can be a side railing or a side wall. Preferably, the side guide element 56 can be arranged outside relative to the object holders 44 and/or the transport path T. For example, the side guide element 56 can have a curved course, which follows the transport path T.

The locking device 58 is shown in FIG. 1 only by way of example. The locking device 58 can be actuated selectively to block or release the inlet stream of the objects 12. A released inlet stream can enter the conveyor 30 so that the objects 12 can be taken over by the motion devices 38. The inlet stream can be blocked by the locking device 58 before entering the conveyor 30, so that no objects 12 are taken over by the motion devices 38. The objects 12 of the inlet stream can then be backed up instead. The locking device 58 can be operated, for example, by the processing device 60.

Preferably, the locking device 58 can be arranged in the inlet region 32 and/or at an end region of the inlet conveyor 14. For example, the locking device 58 can be arranged such that it can block the objects 12 while they are positioned on/at the inlet conveyor 14 or being transported by it. It is also possible that an alternative or additional barrier may be arranged further upstream (e.g., to fulfill at least partial functions). The function could possibly also be achieved through a lateral overlap.

The locking device 58 can be actuated to block the inlet stream, for example, when an error during transport, a malfunction of one of the multiple motion devices 38, a malfunction of one of the multiple magnetic force segments 36, damage to an object 12, a corresponding operator input, and/or a malfunction of a device arranged downstream of the conveyor 30 (e.g., filling apparatus, closure apparatus, or labeling apparatus) for treating and/or transporting the objects 12 is recognized or detected.

The locking device 58 can, for example, have a movable (mechanical) locking element for blocking the objects 12. The locking element can, for example, be a locking finger, a locking pin, or a locking barrier.

The locking element can, for example, be movable between a blocking position and a release position. In blocking position, the objects 12 can be blocked. In the blocking position, the locking element can be used as a stop for a (frontmost) object 12. In the release position, the objects 12 can be released for transport and entry into the conveyor 30.

Preferably, the locking element can be moved by an actuator of the locking device 58. The actuator can, for example, be a mechanical, pneumatic, hydraulic, electrical, or electromagnetic actuator. The mobility of the locking element can, for example, consist in being able to extend and retract and/or pivot it. Damping integrated into the locking element is also conceivable. The actuator can be operated, for example, by the processing device 60.

The processing device 60 is shown in FIG. 1 only by way of example. The processing device 60 can be configured to operate the apparatus 10.

For example, the processing device 60 can be in signal connection with the inlet conveyor 14, the sensor apparatus 24, the outlet conveyor 26, the conveyor 30, the magnetic force segments 36, the magnetic force units 40, and/or the locking device 58.

Preferably, the processing device 60 can operate the magnetic force segments 36 and/or the magnetic force units 40 in such a way that the object holders 44 of the multiple motion devices 38 can take over a continuous or nearly continuous inlet stream of objects in the inlet region 32. Optionally, the motion devices 38 can increase a distance between adjacent, transported objects 12 from the inlet region 32 to the outlet region 34, preferably to a predefined object distance that corresponds to a pitch of the outlet conveyor 26. The motion devices 38 can then transfer the objects 12 to the transport elements 28 of the outlet conveyor 26 at the pitch thereof.

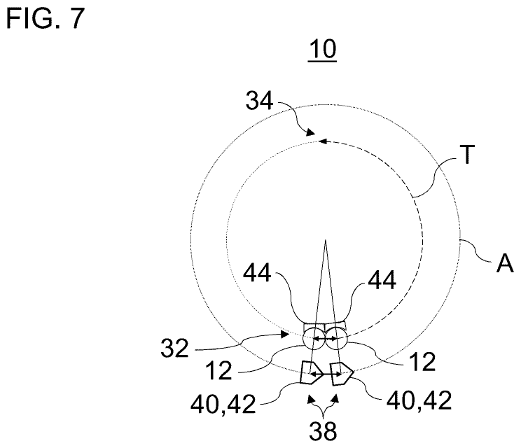

FIG. 7 schematically shows how the arrangement of the transport path T inside relative to the drive path A can have an advantageous effect.

Adjacent magnetic force units 40 (and thus the associated motion devices 38) can be moved so close together that the object holders 44 and/or the objects 12 held by the object holders 44 touch one another. In this state, the housings 42 in which the magnetic force units 40 are accommodated preferably do not yet touch.

The close proximity in the region of the object holders 44 and the objects 12 can ultimately make it possible for the object holders 44 to take over the objects 12 from the substantially or nearly continuous inlet stream from the inlet conveyor 14.

Accordingly, the object holders 44 and the housings 42 in which the magnetic force units 40 are accommodated can be dimensioned in such a way that, when moving together, the object holders 44 and/or the objects 12 touch one another, while the housings 42 are still spaced apart from one another.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the magnetic force segments, the motion devices, the object holders, and/or the magnetic force units of independent claim 1. All ranges specified herein are to be understood as disclosed in such a way that all values falling within the respective range are individually disclosed, e.g., also as the respective preferred narrower outer limits of the respective range.

### LIST OF REFERENCE SIGNS

10 apparatus for transporting
12 object
14 inlet conveyor
16 conveying element
18 frame
20 deflection wheel
22 cutout
24 sensor apparatus
26 outlet conveyor
28 transport element
30 conveyor
32 inlet region
34 outlet region
36 magnetic force segment
38 motion device
40 magnetic force unit
42 housing
44 object holder
46 connecting structure
48 elongated carrier
50 cantilever
52 guide column
54 support plate
56 side guide element
58 locking device
60 processing device
A drive path
T transport path

1. An apparatus for transporting objects wherein the apparatus comprises:
multiple magnetic force segments, wherein the multiple magnetic force segments are arranged side-by-side on a closed, path curve;
multiple motion devices, each of which comprises:
an object holder for holding an object; and
a magnetic force unit for magnetic interaction with the multiple magnetic force segments for driving the respective motion device, wherein:
the magnetic force units are each arranged outside relative to the closed path curve for movement on a circulating drive path; and
the object holders are each arranged for transporting the held objects on a transport path located inside relative to the circulating drive path.

2. The apparatus according to claim 1, wherein:
the multiple magnetic force units can be driven independently of one another by the multiple magnetic force segments,

3. The apparatus according to claim 1, wherein:
the object holders are each arranged inside relative to at least one of the circulating drive path, the closed path curve, the transport path, the multiple magnetic force units, and the multiple magnetic force segments.

4. The apparatus according to claim 1, wherein at least one of the following conditions is met:
the object holders are arranged at a different height than at least one of, the magnetic force units and/or the multiple magnetic force segments,
the transport path is arranged at a different height than, the circulating drive path;
the apparatus is a transport starwheel; and
the multiple magnetic force segments are long stator segments.

5. The apparatus according to claim 1,one wherein:
the multiple motion devices each have a connecting structure, which connects the object holder of the respective motion device and the magnetic force unit of the respective motion device to each other.

6. The apparatus according to claim 5, wherein at least one of the following conditions is met:
the connecting structure is configured at least in portions as a truss;
at least one of the object holder and the magnetic force unit is detachably attached to the connecting structure for replacement;
at least one of the object holder and/or the magnetic force unit is connected to the connecting structure in a height-adjustable manner,
the magnetic force unit is arranged at one of a lower end and an upper end of the connecting structure, and the object holder is arranged at the other of the lower end and the upper end of the connecting structure;
the connecting structure is connected to a central guide column, for guiding and optionally supporting the respective motion device on the central guide column.

7. The apparatus according to claim 5, wherein the connecting structure comprises:
an elongated carrier, wherein the elongated carrier arranged inside relative to the transport path and supports the object holder; and
a cantilever, which connects the elongated carrier and the magnetic force unit.

8. The apparatus according to claim 1, further comprising at least one of the following:
support plate for supporting the objects; held by the object holders, at the base; and
a side guide element for laterally guiding the objects, held by the object holders, on the transport path.

9. The apparatus according to claim lone further comprising:
an inlet conveyor arranged for transferring the objects to the multiple motion devices,
wherein:
the inlet conveyor has a frame with a cutout, wherein
at least one of the cutout spans part of the magnetic force segments, and
portions of the motion devices are movable through the cutout during operation of the apparatus.

10. The apparatus according to claim 1, wherein:
the magnetic force units are accommodated in a housing of the respective motion device; and
the object holders and the housings are dimensioned in such a way that, when adjacent motion devices move together, the object holders and the objects touch one another, while the housings are still spaced apart from one another.

11. The apparatus according to claim 1, wherein:
the multiple motion devices are at least one of: without rollers and/or are guided on a central guide column of the apparatus; or
the multiple motion devices each have at least one guide roller, which guides nd the respective motion device along a circulating guide track.

12. The apparatus according to claim 1, further having:
a locking device, which is arranged in an inlet region of the apparatus and can be actuated to selectively block or release an object inlet stream.

13. The apparatus according to claim 1, further having:
a processing device configured to operate at least one of the multiple magnetic force segments and magnetic force units in such a way that at least one of:
the object holders of the multiple motion devices can take over a continuous or nearly continuous object inlet stream, and,
the motion devices increase or decrease a distance between adjacent, transported objects from an inlet region to an outlet region of the apparatus, to a predefined object distance.

14. A method for transporting objects, wherein the method comprises:
transporting the objects on a transport path by object holders of multiple motion devices, wherein:
the transport path is arranged inside relative to a circulating drive path;
magnetic force units of the multiple motion devices move on the circulating drive path driven by magnetic interaction with multiple magnetic force segments arranged side-by-side on a closed path curve; and
the circulating drive path is arranged outside relative to the closed path curve.

15. The method according to claim 14, wherein the method further comprises at least one of the following:
taking over the objects by the object holders of the multiple motion devices from a continuous or a nearly continuous object inlet stream;
transferring the objects by the object holders of the multiple motion devices to an object outlet stream, in which adjacent objects are positioned at a predefined object distance from one another;
pushing the objects during the transporting by the object holders of the multiple motion devices over at least one of a support plate and along a side guide element;
blocking an object inlet stream to the multiple motion devices by a locking device, which device is arranged downstream of the multiple motion devices;
detected damage to an object; and
an operator input.

16. The apparatus of claim 2 wherein the multiple magnetic force units and the multiple magnetic force segments together form a long-stator linear-motor drive system or a short-stator linear-motor drive system or a planar-motor drive system.

17. The apparatus of claim 3 wherein the object holders for holding the objects are oriented outwards and the object holders are contain-er holders, for holding one container each at at least one of a container neck of the container and at a container body of the container.

18. The apparatus according to claim 8, wherein at least one of the following conditions is met:
the support plate is stationary;
the support plate is arranged between the object holders and the magnetic force segments;
the support plate has a curved course, which follows the transport path;
the side guide element is arranged outside relative to at least one of the object holders and the transport path; and
the side guide element has a curved course, which follows the transport path.

19. The method according to claim 15, wherein said step of blocking said object inlet stream occurs in the event of at least one of the following:
an error during transport, takeover, or transfer;
a malfunction of one of the multiple motion devices;
a malfunction of one of the multiple magnetic force segments; and
a malfunction of a device for treating and transporting the objects.

20. The method according to claim 14, wherein at least one of:
the objects are containers; and
the method is carried out by an apparatus according to claim 1.
